(19) United States
(12) Patent Application Publication
(10) Pub. No.: US 2008/0122748 A1
(43) Pub. Date: May 29, 2008

(54) Plasma display device

(76) Inventor: Jaeyoung Yeo, Gyeonggi-do (KR)

Correspondence Address: ROBERT E. BUSHNELL, 1522 K STREET NW, SUITE 300, WASHINGTON, DC, 20005-1202, US

(21) Appl. No.: 11/984,987

(22) Filed: Nov. 26, 2007

(30) Foreign Application Priority Data
Nov. 27, 2006 (KR) 10-2006-0117891

(51) Int. Cl. G09G 3/28

(52) U.S. Cl. 345/60

(57) ABSTRACT

A plasma display device that reduces ElectroMagnetic Interference (EMI) generated by switching during energy recovery includes: a logic controller to receive an image signal and to generate a control signal according to the image signal; a driver to receive the image signal and the control signal and to generate a driving signal for the output of the image signal, the driver including an energy recovery circuit to recover extra electrical power during the generation of the driving signal; and a display panel to output an image corresponding to the image signal according to the driving signal; the energy recovery circuit includes a resonance inductor to recover and re-supply electrical power and a bypass circuit connected in parallel with the resonance inductor.

### CLAIM OF PRIORITY

This application makes reference to, incorporates the same herein, and claims all benefits accruing under 35 U.S.C. § 119 from an application for PLASMA DISPLAY DEVICE earlier filed in the Korean Intellectual Property Office on the 27 Nov. 2006 and there duly assigned Serial No. 2006-0117891.

### BACKGROUND OF THE INVENTION

1. Field of the Invention

The present invention relates to a plasma display device, and more particularly, the present invention relates to a plasma display device that can reduce ElectroMagnetic Interference (EMI) generated by switching during energy recovery.

2. Description of the Related Art

A plasma display device generates a discharge by a driving signal of a high voltage supplied in a digitalized form and generates visible light rays from ultraviolet rays generated by the discharge so as to display an image. As a result thereof, the plasma display device uses a high voltage driving signal as compared with other drivers. Accordingly, the plasma display device consumes a lot of electrical power to generate the driving signal. Various methods have been studied to minimize the consumption of electrical power for the generation and use of the driving signal for the plasma display device.

The most typical method is a weber type Energy Recovery Circuit (ERC), which is mainly used. The weber type ERC is implemented by a storage capacitor (Cst), a switch for the charge and discharge of the storage capacitor (Cst), and a resonance inductor (L) for the resonance of the storage capacity. In spite of its structural simplicity, the ERC is mainly used because of its high energy recovery efficiency, its high-speed response and its easy control.

However, the weber type ERC has a problem in that it generates high level EMI during the energy recovery operation. The problem is mainly caused by the inductor because the voltage is input to the inductor during the charge or the discharge of an extra energy. The plasma display device supplies the voltage to the panel by a discharge switch, when the driving signal is initially supplied. The charged voltage is supplied to the plasma display panel through a resonance inductor, and also charged in the resonance inductor. A separate driving power supply supplies a signal power to the plasma display panel when the charged voltage supply is finished, and is also supplied to the one terminal of the inductor. As a result thereof, a voltage across the resonance inductor becomes a sum of the inductor voltage charged by the charge voltage and the voltage supplied by the driving power supply. This not only increases the voltage across the resonance inductor, but also affects the driving of a switch coupled to the resonance inductor, thereby generating EMI by an overshoot, that is, a ringing at the time of switching.

FIG. 1 is a waveform diagram of the overshoot generated by a switch when a sustain signal is supplied.

Referring to FIG. 1, a sustain waveform is ideally supplied as a square waveform. However, the sustain waveform having a predetermined slope is supplied due to the energy recovery operation when the signal voltage is supplied and stopped. The lower waveform of FIG. 1 shows switch-on/off operation that discharges the voltage charge of a storage capacitor (Cst). A high state indicates the discharge switch-on state, and a low state indicates the discharge switch-off state. The discharge switch maintains the off state while the sustain pulse is not being supplied. As shown in “A” of FIG. 1, the overshoot is produced by the voltage charged at the resonance inductor when the discharge switch is changed from the switch-off state to the switch-on state. The overshoot is generated continuously when the sustain pulse is supplied, thereby hindering normal operation of the plasma display device due to high intensity EMI. The overshoot causes the cost of the plasma display device to be increased, because the rated withstanding voltage of the elements arranged at both terminals of the inductor must be increased.

To solve the problems, a method of forming a manifold circuit using an element to remove the overshoot has been utilized. However, this increases the complexity of the circuit and causes control difficulties when the driving signal is supplied. It also increases the manufacturing cost due to the addition of the element.

### SUMMARY THE INVENTION

One aspect of the present invention is to provide a plasma display device that can reduce ElectroMagnetic Interference (EMI) generated by switching during energy recovery.

Another aspect of the present invention is to provide the plasma display device having a bypass circuit that can reduce a voltage across a resonance inductor to reduce the voltage load of elements connected to the resonance inductor.

Still another aspect of the present invention is to provide the plasma display device having a bypass circuit for reducing the voltage load of the elements connected to the resonance inductor so as to allow the use of lower priced elements than before and to guarantee stable operation of the elements.

Yet another aspect of the present invention is to provide the plasma display device having a bypass circuit that can reduce EMI withstanding voltage by using a field effect transistor without needing an additional drive IC for the control of the bypass circuit and an increased design load.

According to one aspect of the present invention, a plasma display device is provided including: a logic controller to receive an image signal and to generate a control signal in accordance with the image signal; a driver to receive the image signal and the control signal and to generate a driving signal for the output of the image signal, the driver including an energy recovery circuit to recover extra electrical power during the generation of the driving signal; and a display panel to output an image corresponding to the image signal according to the driving signal; the energy recovery circuit includes a resonance inductor to recover and re-supply electrical power and a bypass circuit connected in parallel with the resonance inductor.

The resonance inductor may include a first terminal electrically coupled to the display panel, and a second terminal electrically coupled to a storage capacitor to store and discharge the extra electrical power.

The bypass circuit may further include: at least one diode to define a bypass path between the first and second terminals; and at least one switch to control a voltage input to the bypass circuit. The at least one switch may include a field effect transistor. The at least one diode may include a parasitic diode of the field effect transistor.

The at least one diode may include: a first diode to define a first bypass path from the second terminal to the first terminal and a second diode to define a second bypass path from the first terminal to the second terminal.

The at least one switch may include: a first switch to control voltage supplied to the first bypass path and a second switch to control a voltage supplied to the second bypass path.

The driver may include at least one of an address driver, a scan driver, and a sustain driver.

The energy recovery circuit recovers electrical power in response to at least one of an address signal, a scan signal, and a sustain signal being supplied.

The driver may include a signal voltage source to generate the driving signal, and a signal voltage supplying switch to supply the signal voltage to the display panel.

The first and second switches are turned on either in response to the signal voltage supplying switch being turned on or before the signal voltage supplying switch has been turned on.

The signal voltage may include at least one of an address voltage, a scan voltage, and a sustain voltage.

The first switch is turned on in response to the signal voltage supplying switch being turned on to supply at least one of the address voltage, the scan voltage, and the sustain voltage.

The second switch is turned on in response to the signal voltage supplying switch being turned on to supply a ground voltage.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a waveform diagram of the overshoot generated by a switch when a sustain signal is supplied;

FIG. 2 is a block diagram of a plasma display device;

FIGS. 3a, 3b, and 3c are block diagrams of each driver of FIG. 2;

FIG. 4 are driving waveforms supplied to the plasma display device of an embodiment of the present invention;

FIG. 5 is a circuit diagram of a scan driver;

FIG. 6 are waveform diagrams of the timing of a switch according to each section by dividing a sustain signal into a plurality of sections; and

FIGS. 7a, 7b, 7c and 7d are circuit diagrams of voltage supply paths of FIG. 6.

### DETAILED DESCRIPTION OF THE INVENTION

Hereinafter, exemplary embodiments of the present invention are described in detail with reference to the accompanying drawing. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are merely specific details provided to assist those of ordinary skill in the art in a comprehensive understanding of the present invention. The present invention is only defined by the scope of the appended claims.

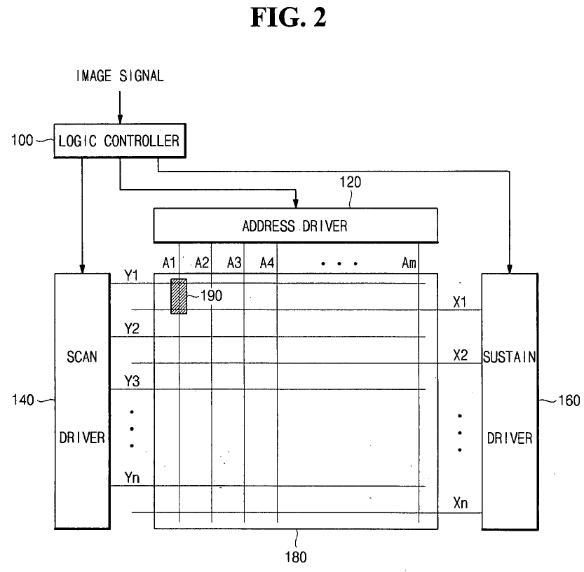

FIG. 2 is a block diagram of a plasma display device.

Referring to FIG. 2, the plasma display device includes a logic controller 100, an address driver 120, a scan driver 140, a sustain driver 160 and a display panel 180.

The logic controller 100 receives an external image signal and provides the received image signal and a control signal to the address driver 120, the scan driver 140, and the sustain controller 160. The control signal may include a switching control signal that controls the on-off operation of a switch contained within an address driver 120, a scan driver 140, and a sustain driver 160. However, the present invention is not limited thereto.

The address driver 120 generates an address signal under the control of the logic controller 100, and supplies the generated address signal to the display panel 180. The address signal is synchronized with the scan signal from the scan driver 140 to select a discharge cell 190. Also, the address driver 120 may include an energy recovery circuit. The energy recovery circuit may include a bypass circuit.

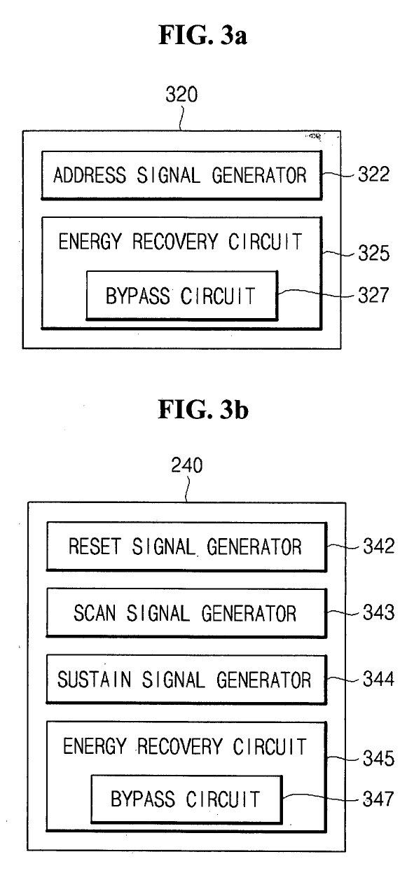

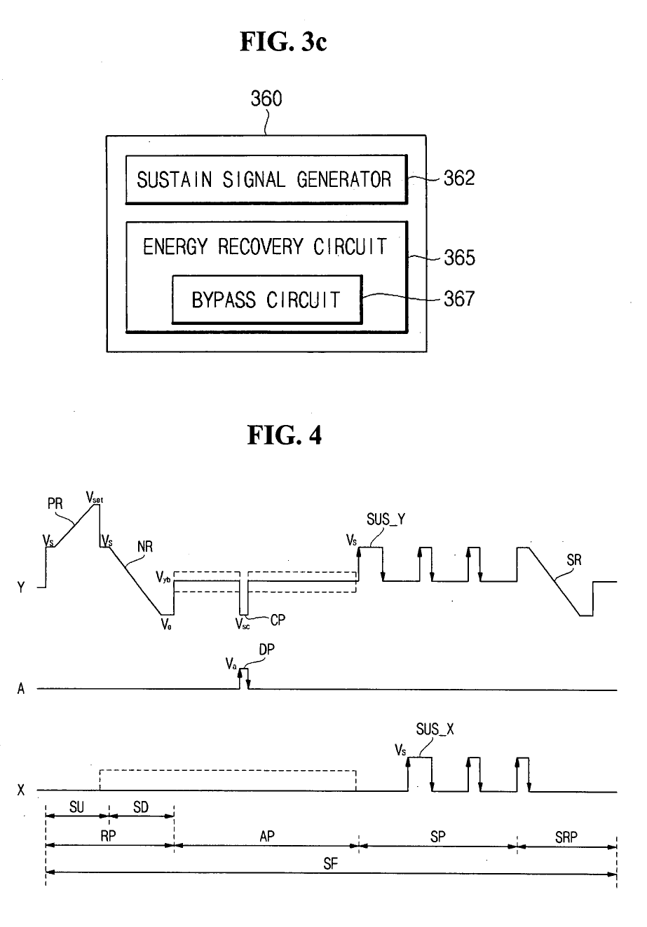

The bypass circuit is explained in detail as follows with reference to FIGS. 3a-3c and FIG. 4. The energy recovery circuit stores the extra electrical power when the address signal is supplied, and reduces the electrical power consumption due to the supply of the address signal by supplying the stored electrical power when a subsequent address signal is supplied. For this, the energy recovery circuit includes a storage capacitor and a resonance inductor, and the bypass circuit is arranged in parallel with the resonance inductor. The energy recovery circuit and the bypass circuit may be formed in the address driver 120. However, the present invention is not limited thereto.

The scan driver 140 generates a reset signal, a scan signal and a sustain signal under the control of the logic controller 100 and supplies the generated signals to the display panel 180. The scan driver 140 initializes each discharge cell of the display panel by the reset signal for the best condition of the address discharge. Also, the scan driver 140 selects the discharge cell by supplying the scan signal synchronized with the address signal. The scan driver 140 supplies the sustain signal so that the image is displayed by the display discharge. The scan driver 140 forms a bypass circuit to prevent the overshoot due to the switching during the energy recovery operation. The bypass circuit uses the same principle as the bypass circuit included in the address driver. This is explained in detail below with reference to FIGS. 3a-3c and 4.

The sustain driver 160 generates the sustain signal under the control of the logic controller 100 and supplies it to the display panel 180. The sustain driver 160 causes the display discharge in the discharge cell 190 together with the scan driver 140. Also, the bypass circuit may be included in the sustain driver 160.

The bypass circuit is connected in parallel with the resonance inductor included in the energy recovery circuit, thereby providing the discharge path of the inductor voltage stored in the resonance inductor. The bypass circuit prevents the overshoot from being generated by the inductor voltage.

The display panel 180 displays the image by causing the discharge in a plurality of discharge cells 190 according to the driving signal supplied from an address driver 120, a scan driver 140, and a sustain driver 160. FIG. 2 shows the plasma display panel 180 of a single scan method, wherein the address electrode (A1˜Am:A) is formed in the perpendicular direction, and the scan electrode (Y1˜Yn:Y) and the sustain electrode (X1˜Xn:X) are formed in a parallel direction with the address electrode (A) to intersect each other. The discharge cell 190 is formed at the intersection of the perpendicular electrode (A) and the parallel electrode (Y, X). The arrangement of the display panel 180 and the drivers 120, 140 and 160 is merely an example. However, the present invention is not limited thereto.

FIGS. 3a, 3b, and 3c are block diagrams of each driver of FIG. 2.

The address driver 120 of FIG. 2 may correspond to the driver of FIG. 3a. In other words, the address driver 320 may include an address signal generator 322 for generating an address signal and an energy recovery circuit 325 for assisting the generation of the address signal. The energy recovery circuit 325 may include a bypass circuit 327. The address signal generator 322 of the address driver 320 generates the address signal to select the discharge cell. The address signal is a signal having a high level and a low level voltage level. The high level signal may be generated by supplying the address power by switching. This enables the operation of the energy recovery to occur after the address signal has been supplied. The energy recovery circuit 325 supplies the charged voltage after the address signal has been supplied, and performs the energy recovery operation. The bypass circuit 327 forms a separate path in order not to supply some of the voltage of the energy recovery circuit 325 to the resonance inductor, thereby preventing the overshoot that may be generated when the address signal is supplied. Although the energy recovery circuit 325 is different from the address signal generator 322, it can be considered to be a part of the address signal generator 322 because the energy recovery circuit 325 included in the address driver 320 performs the charge or discharge for the generation of the address signal. The energy recovery circuit 325 of the address driver 320 and the bypass circuit 327 may also not be contained within the address driver 320.

FIG. 3b is a block diagram of the scan driver 240.

Referring to FIG. 3b, the scan driver 240 includes a reset signal generator 342, a scan signal generator 343, a sustain signal generator 344 and an energy recovery circuit 345 including a bypass circuit 347.

The reset signal generator 342 generates the reset signal for the initialization of the discharge cell. The scan signal generator 343 generates the scan signal to select the discharge cell by synchronizing with the address signal of the address driver 320. The sustain signal generator 344 generates and supplies the sustain signal to cause the display discharge for the image display.

The scan driver 240 may perform the energy recovery operation when the scan signal generator 343 and sustain signal generator 344 are operated, but it is assumed for illustrative purposes that the energy recovery operation is performed when the sustain signal generator 344 is operated. However, the present invention is not limited thereto.

The sustain signal is generated by repeating the supplying and stopping of the sustain voltage by switching. Like the address signal, the stored energy from the energy recovery circuit 345 is discharged when the sustain signal is supplied, and the energy is stored by the energy recovery circuit 345 when the sustain signal has stopped. The bypass circuit 347 reduces the generation of EMI by preventing the voltage across the resonance inductor from being a higher voltage than required due to the sum of the inductor voltage and the sustain voltage during the storing and the discharging.

FIG. 3c is a block diagram of the sustain driver 360.

The sustain driver 360 may include a sustain signal generator 362 and an energy recovery circuit 365 including a bypass circuit 367 as shown in FIG. 3c. A detailed explanation of the sustain driver 360 has been omitted because the method of generating the sustain signal and the energy recovery operation of the scan driver 240 of FIG. 3b are similarly performed. Although the sustain driver 360 is shown to be different from the scan driver 240, it may include the scan driver 240. In this case, its driving method may be changed a little.

FIG. 4 are driving waveforms that can be supplied to the plasma display device of an embodiment of the present invention.

Referring to FIG. 4, the method of driving the plasma display device can easily apply the driving method by the subfield. In other words, after dividing 1 TV field into a plurality of subfields, each subfield is divided into a reset period, an address period, and sustain period. Each subfield (SF) has a different display weight value, or a gray level weight value, and an image may be displayed by the combination of subfields having different weight values. However, the present invention is not limited thereto.

In FIG. 4, a method of using the subfields divided into a characteristic period is shown as one example.

One subfield (SF) is divided into a reset period (RP), an address period (AP) and a sustain period (SP). It is possible that the reset period (RP) is divided into a main reset period (RP) and a supporting reset period (SRP) according to the driving method.

The reset signals (PR, NR, SR) are supplied to make the environment of the discharge cell to a state suitable for the address discharge and the sustain discharge for the reset period (RP). The reset signals (PR, NR, SR) are supplied from the reset signal generator of the scan driver, and include a rising lamp signal (PR) and a falling lamp signal supplied for a main reset period (RP), and a supplementary reset signal (SR) supplied for a supplementary reset period (SRP).

A main reset period, one of the reset period (RP), is divided into a setup period (SU) that generates a large amount of wall charges inside the discharge cell, and a set-down period (SD) that reduces the excessively generated wall charges to a suitable level for the address discharge and accomplishes the arrangement of the wall charges of the electrode. On the other hand, the supplementary reset period (SRP) is provided with the shape of the omitted setup period (SU) compared with the main reset period.

The scan voltage (Vs) and the rising lamp signal (PR) increasing sequentially from the scan voltage (Vs) to the peak voltage (Vset) are supplied for the setup period (SU), thereby actively generating the wall charges in the discharge cell, and resulting in a large amount of the existing wall charges.

The falling lamp signal (PR) decreasing from the scan voltage (Vs) to the erase voltage (Ve) are supplied for the set-down period (SD), thereby sequentially erasing the excessively generated wall charges.

On the other hand, a reference voltage (for example, a ground voltage) is supplied to the address electrode (A) and the sustain electrode (X) for the reset period (RP). The dotted line of FIG. 4 is to show the partly changed driving waveform, and it shows one example of the bias voltage. The bias voltage may be variously provided, such as shown by the dotted line, to control the discharge between the electrodes and the arrangement of the wall charges. However, the present invention is not limited thereto.

For the address period, the address signal (DP) is supplied to the address electrode (A), and the scan signal (CP) is supplied by synchronizing with it to the scan electrode (Y). The address signal (DP) is supplied by the address voltage (Va) of a positive polarity, and the scan signal (CP) is supplied by the scan voltage (Vsc) of a negative polarity. The scan signal (CP) of a single scan method is sequentially supplied to the scan electrode (Y). The address discharge is generated by the scan signal (CP) and the address signal (DP), and the discharge cell performing the display discharge has the arrangement of the wall charges suitable for the sustain discharge. Although the existence or nonexistence of the discharge in the selected discharge cell becomes different according to a selective writing method and a selective erasing method, the use of the selective writing method is assumed to explain the present invention.

For the sustain period (SP), the sustain signal (SUS_X and SUS_Y) is alternatively supplied to the scan electrode (Y) and the sustain electrode (X). The weight value is decided by the alternatively supplied sustain signal (SUS_X and SUS_Y), and then the image display is displayed.

On the other hand, the direction of an arrow (↑↓) shows the charge (↓) and the discharge (↑) of the energy recovery circuit in FIG. 4. Especially, the charge and the discharge (↑↓) is shown only for the address signal (DP) and the sustain signal (SUS_X and SUS_Y) in FIG. 4. However, the present invention is not limited thereto.

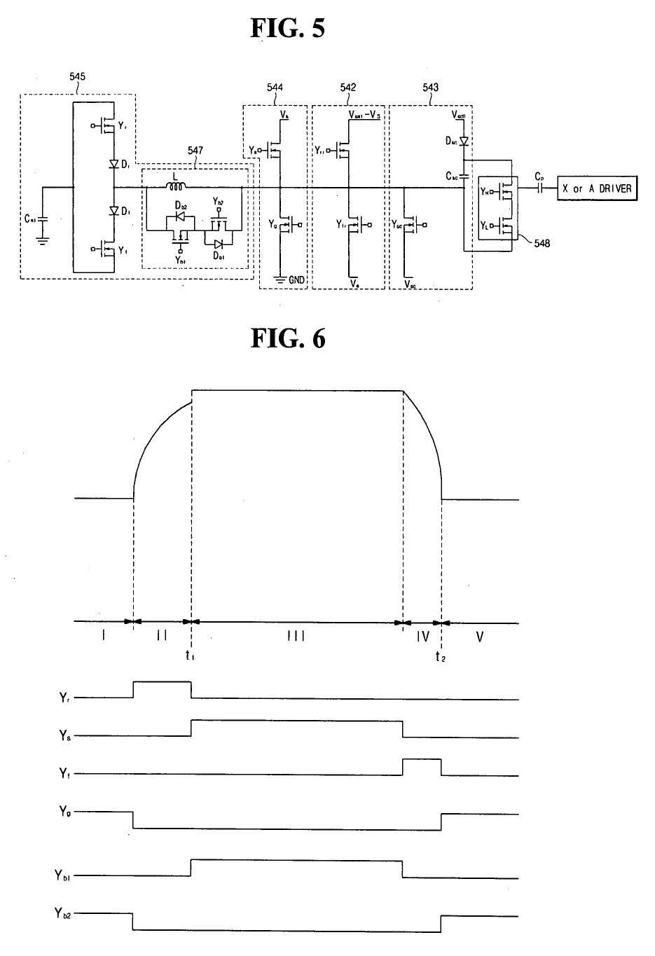

The energy stored by the energy recovery circuit is supplied to the electrode (↑) when the sustain signal (SUS_X and SUS_Y) is supplied, and the extra energy is stored by the energy recovery circuit when the sustain signal (SUS_X and SUS_Y) supply (↓) has ended. Since the sustain signal (SUS_X and SUS_Y) is supplied more times than the other signals, the highest reduction of the electrical power consumption may be anticipated during the operation of the electrical power recovery. Though the number of discharge times is less than that of the sustain signal (SUS_X and SUS_Y), the address signal (DP) may realize the operation of the energy recovery. However, the present invention is not limited thereto. An example of the circuit generating the driving waveforms of FIG. 4 is shown in FIG. 5. The realized examples of the bypass circuit and the energy recovery circuit are shown in FIG. 5.

FIG. 5 is a circuit diagram of the scan driver. The energy recovery operation is shown as being performed when the sustain signal is generated. However, the present invention is not limited thereto.

Referring to FIG. 5, the scan driver includes a reset signal generator 542, a scan signal generator 543, a sustain signal generator 544 and an energy recovery circuit 545. The energy recovery circuit 543 includes a bypass circuit 547. The scan driver may further include a scan IC 548 that is arranged at a front end of the display panel (Cp) and provides another path according to the scan signal.

The reset signal generator 542 includes a peak voltage source (Vset-Vs), an erase voltage source (Ve), a rising switch (Yrr) and a falling switch (Yfr). The peak voltage source (Vset-Vs) is a voltage source to supply the peak voltage (Vset) of the rising lamp signal (PR). The voltage supplied from the peak voltage source (Vset-Vs) is converted to a sequentially rising lamp signal by the rising switch (Yrr) so as to be supplied to the display panel. The erase voltage source (Ve) is a voltage source to generate the falling lamp signal (NR), and it is converted to a sequentially falling lamp signal by the falling switch (Yfr) so as to be supplied to the display panel.

The scan signal generator 543 includes two voltage sources of the scan high-voltage source (VscH) and the scan voltage source (Vsc), a diode (Dsc) to prevent a reverse current, a capacitor (Csc) and a scan switch (Ysc). The scan high-voltage source (VscH) is the voltage corresponding to the dotted line of FIG. 4, and serves as a bias voltage to smoothly generate the address discharge. The scan voltage source (Vsc) is the voltage to generate the scan signal, and the capacitor (Csc) stores the difference voltage (VscH−Vsc) between the scan-high voltage and the scan voltage, thereby supporting the generation of the scan signal. The high level switch (Y_{H}) of the scan IC 548 is turned on when the scan high-voltage (VscH) is supplied to the display panel (Cp), and the low level switch (Y_{L}) is otherwise turned on.

The sustain signal generator 544 includes a sustain voltage (Vs), a ground voltage (GND), a sustain switch (Ys) and a ground switch (Yg). The sustain signal generator 544 supplies the sustain voltage (Vs) to the display panel by turning on the sustain switch (Ys) when the sustain signal is supplied. The ground power supply (GND) is connected to the display panel (Cp) by the ground switch (Yg) when the sustain signal is supplied by the sustain driver or the sustain voltage stored on the display panel is discharged. The sustain signal generator 544 and the energy recovery circuit 545 are shown as having separate constitutions in FIG. 5. However, it is possible to consider that the sustain signal generator 544 includes the energy recovery circuit 545 because the energy recovery operation is carried out by the energy recovery circuit 545 when the sustain signal generator 544 is operated. However, the present invention is not limited thereto.

The energy recovery circuit 545 includes a resonance inductor (L), a storage capacitor (Cst), a charge switch (Yr), a charge diode (Dr), a discharge switch (Yf), a discharge diode (Df) and a bypass circuit 547.

The storage capacitor (Cst) stores the extra electrical power generated by supplying the sustain signal to the display panel (Cp), and supplies the electrical power stored by a new sustain signal being supplied to the display panel (Cp). The voltage stored by the storage capacitor (Cst) is supplied to the display panel (Cp) by the charge switch (Yr), and the extra electrical power of the display panel (Cp) is stored in the storage capacitor (Cst) by the discharge switch (Yf). The resonance inductor (L) is arranged between the storage capacitor (Cst) and the display panel (Cp) to generate the charging and the discharging of the storage capacitor (Cst) by causing a resonance with the storage capacitor (Cst).

The bypass circuit 547 prevents the voltage across the resonance inductor from increasing by the signal voltage supplied to the resonance inductor. The bypass circuit 547 is connected in parallel with the resonance inductor (L), thereby bypassing some voltage supplied to the resonance inductor (L). The bypass circuit 547 includes a first switch (Yb1), a second switch (Yb2), a first diode (Db1) and a second diode (Db2). After supplying the voltage from the storage capacitor (Cst) to the display panel, the first switch (Yb1) and the first diode (Db1) form the bypass path when the sustain power supply (Vs) supplies the power supply to the display panel (Cp). The second switch (Yb2) and the second diode (Db2) form the bypass path when the sustain signal has ended, and the ground power supply (GND) is supplied after the charging of the storage capacitor (Cst). The bypass circuit 547 prevents an overshoot from being generated due to the voltage supplied to the resonance inductor (L).

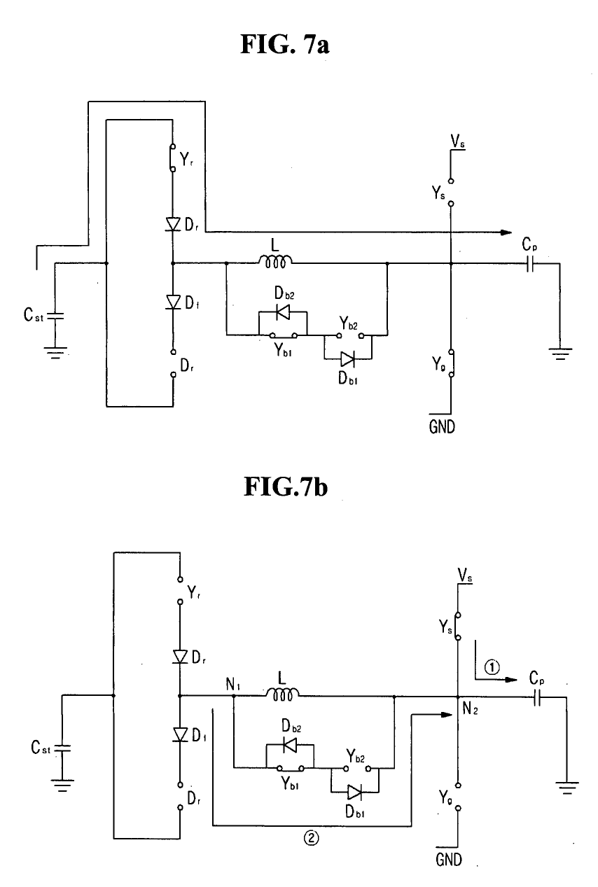

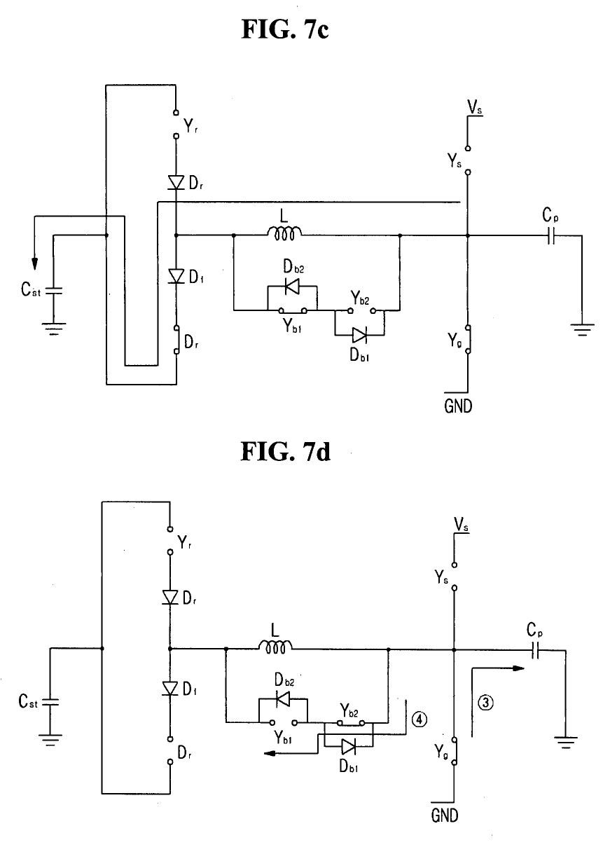

FIG. 6 are waveform diagrams of the timing of a switch according to each section by dividing a sustain signal into a plurality of sections. FIGS. 7a, 7b, 7c and 7d are circuit diagrams of voltage supply paths of FIG. 6.

Referring to FIG. 6, one sustain signal may be approximately divided into 4 sections. Although one sustain signal is divided into 5 sections from I to V in FIG. 6 for a convenient explanation, it may be considered that Section I and Section V are actually the same.

Section I in FIG. 6 may be a silent period occurred after supplying the previous sustain signal or a silent period occurred after the addressing. The voltage supplied to the display panel (Cp) is discharged to maintain the ground potential (GND) during the silent period.

The sustain signal is supplied in Sections II to IV. The voltage stored by the storage capacitor (Cst) is supplied to the display panel by turning-on the charge switch (Yr) in Section II. The storage capacitor (Cst) is assumed to be charged when the previous sustain signal has been supplied or by the power supply. The voltage stored by the storage capacitor (Cst) is supplied to the display panel (Cp) by causing a resonance with the resonance inductor (L) in Section II. As a result thereof, the sustain signal has a shape of an ascending parabola in Section II.

The sustain voltage (Vs) is supplied to the display panel (Cp) by turning-on the sustain switch at a first time (t1) that is converted from Section II to Section III. The voltage waveform of the sustain signal having the ascending parabola shape is changed to a rapidly ascending shape. The flat voltage section is formed due to the application of the sustain voltage (Vs) in Section III, and the display discharge occurs in Section III.

As soon as the sustain switch (Ys) is turned off, the discharge switch is turned on in Section IV. The voltage stored by the display panel (Cp) is stored by the storage capacitor (Cst) by the resonance inductor (L). The voltage of the sustain signal descends with the parabola shape.

The ground switch (Yg) is turned on and the voltage (Vs) at the display panel (Cp) is completely discharged as soon as the discharge switch (Yf) is turned off at a second time (t2) converted from Section IV to Section V. One sustain signal is completed by the switching from Section I to Section V.

The generation of EMI is increased at the first time (t1) and the second time (t2). The voltage discharged from the storage capacitor (Cst) passes though the resonance inductor (L) in Section II, thereby charging the inductor voltage in the resonance inductor (L). The sum of the inductor voltage and the sustain voltage (Vs) is supplied across the inductor because the sustain voltage (Vs) is supplied from the sustain power supply (Vs) at the time (t1). This phenomenon is similarly generated with a different phase at the second time (t2).

The inductor voltage may cause the EMI to be generated by the overshoot. This is prevented by lowering the voltage across the resonance inductor (L) through the bypass circuit in the present invention.

More particularly, the first switch (Yb1) is turned on as soon as the sustain switch is turned on or before the sustain switch is turned on. The sustain voltage (Vs) is supplied to the path formed by the bypass circuit, not by the resonance inductor when the sustain switch (Ys) is turned on, thereby providing the discharge path of the voltage charged at the resonance inductor (L). The overshoot generated by the sum voltage of the sustain voltage (Vs) and the inductor voltage may be prevented by providing free paths, regardless of discharging the voltage of the resonance inductor (L) or the resonance inductor (L) being charged with the voltage.

FIGS. 7a, 7b, 7c and 7d are circuit diagrams illustrating paths that the circuit of FIG. 5 is divided according to the section of FIG. 6.

FIG. 7a shows the circuit state and the supply path of the voltage in Section II.

Referring to FIG. 7a, when the charge switch (Yr) is turned on in Section II that the sustain signal starts to be supplied, and the voltage supply path is formed by a storage capacitor (Cst), a charge switch (Yr), a charge diode (Dr), a resonance inductor (L) and a display panel (Cp). In this time, the resonance inductor (L) may be charged by the voltage supplied to the display panel (Cp) from the storage capacitor (Cst).

FIG. 7b shows the voltage supply path in Section III of FIG. 6.

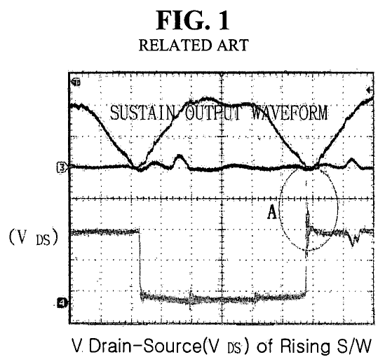

Referring to FIG. 7b, As soon as the sustain switch (Ys) is turned on in Section III, the sustain voltage (Vs) is supplied. Then the charge switch (Yr) is turned off, and the voltage supply from the storage capacitor (Cst) is stopped. The voltage supply path is divided into a first path \textcircled{1} supplying to the display panel by the sustain power supply and a second path \textcircled{2} supplied through the bypass circuit. The second path \textcircled{2} is formed by a first switch (Yb1) that is turned on simultaneously with the sustain switch (Ys) or turned on earlier than the sustain switch (Ys), and a first diode (Db1). The second path \textcircled{2} prevents the voltage of the first node (N1) and the second node (N2) from being instantly increased due to the sum of the sustain voltage and the inductor voltage charged temporarily to the resonance inductor (L). In other words, the overshoot voltage is generated when the charge switch is turned off and the sustain switch is turned on. Accordingly, by bypassing the overshoot voltage through the first switch (Yb1) and the first diode (Db1) without passing through the resonance inductor, the voltage of the first node (N1) and the second node (N2) can be maintained stably. The first switch (Yb1) is set to be turned on for the same time as that of the sustain switch (Ys) for the convenience of its control as shown in FIG. 6. The first switch (Yb1) may perform the bypass operation when it is turned on for a shorter period than the turn-on period of the sustain switch (Ys). Since the overshoot temporarily occurs at the turn-off of the charge switch as shown in FIG. 1, it is enough to form the bypass even if the first switch (Yb1) is turned on only for the period. It is possible to use the element having a lower withstanding voltage to reduce the unnecessary voltage load supplied to the charge switch (Yr), the discharge switch (Yf), the charge diode (Dr) and the discharge diode (Df) by passing through the bypass circuit.

FIG. 7c shows the voltage supply path in Section IV. In Section IV, the voltage charged at the display panel (Cp) is stored in the storage capacitor (Cst) because the sustain signal has ended. The sustain switch (Ys) and the first switch (Yb1) is turned off, and the discharge switch is turned on, thereby forming the same path as shown in FIG. 7c. Accordingly, the electrical power remaining in the display panel is stored by the storage capacitor (Cst).

FIG. 7d shows a voltage supply path in Section V. The ground switch (Yg) is turned on and connected to the ground power supply (GND) and the display panel (Cp) to completely discharge the voltage of the display panel (Cp) (path \textcircled{3}) in Section V. The second switch (Yb2) is turned on differently from that of FIG. 7b, and bypassed by the second switch (Yb2) and the second diode (Db2) (path \textcircled{4}), thereby preventing the voltage across the resonance inductor (L) from being temporarily increased when the display panel (Cp) is discharged.

The first and second diodes (Db1, Db2) may be implemented by separate diodes. However, if the first and second switches (Yb1, Yb2) are implemented using a field effect transistor, they may be implemented using a parasitic diode.

As described above, the plasma display device according to the present invention produces the following effects.

The plasma display device according to the present invention can reduce the EMI generated by the rapid increased voltage across the resonance inductor at the time of the switching of the energy recovery operation.

The plasma display device according to the present invention can reduce the voltage across the resonance inductor and the voltage load of the element connected to the resonance inductor using the bypass circuit.

The plasma display device according to the present invention can use a less expensive element than before and guarantee the stable operation of the element by reducing the voltage load of the element connected to the resonance inductor.

The plasma display device according to the present invention can reduce EMI effects and the withstanding voltage by using a field effect transistor without needing an additional drive IC for the control of the bypass circuit and increasing the design load.

It should be understood by those of ordinary skill in the art that various replacements, modifications and changes in form and detail may be made therein without departing from the spirit and scope of the present invention as defined by the following claims. Therefore, it is to be appreciated that the above described embodiments are for the purpose of illustration only and are not to be construed as being limitations of the present invention.

What is claimed is:

1. A plasma display device, comprising:
a logic controller to receive an image signal and to generate a control signal in accordance with the image signal;
a driver to receive the image signal and the control signal and to generate a driving signal for the output of the image signal, the driver comprising an energy recovery circuit to recover extra electrical power during the generation of the driving signal; and
a display panel to output an image corresponding to the image signal according to the driving signal;
wherein the energy recovery circuit comprises a resonance inductor to recover and re-supply electrical power and a bypass circuit connected in parallel with the resonance inductor.

2. The plasma display device of claim 1, wherein the resonance inductor comprises a first terminal electrically coupled to the display panel, and a second terminal electrically coupled to a storage capacitor to store and discharge the extra electrical power.

3. The plasma display device of claim 2, wherein the bypass circuit further comprises:
at least one diode to define a bypass path between the first and second terminals; and
at least one switch to control a voltage input to the bypass circuit.

4. The plasma display device of claim 3, wherein the at least one switch comprises a field effect transistor.

5. The plasma display device of claim 4, wherein the at least one diode comprises a parasitic diode of the field effect transistor.

6. The plasma display device of claim 5, wherein the at least one diode comprises: a first diode to define a first bypass path from the second terminal to the first terminal and a second diode to define a second bypass path from the first terminal to the second terminal.

7. The plasma display device of claim 6, wherein the at least one switch comprises: a first switch to control voltage supplied to the first bypass path and a second switch to control a voltage supplied to the second bypass path.

8. The plasma display device of claim 7, wherein the driver comprises at least one of an address driver, a scan driver, and a sustain driver.

9. The plasma display device of claim 8, wherein the energy recovery circuit recovers electrical power in response to at least one of an address signal, a scan signal, and a sustain signal being supplied.

10. The plasma display device of claim 9, wherein the driver comprises a signal voltage source to generate the driving signal, and a signal voltage supplying switch to supply the signal voltage to the display panel.

11. The plasma display device of claim 10, wherein the first and second switches are turned on either in response to the signal voltage supplying switch being turned on or before the signal voltage supplying switch has been turned on.

12. The plasma display device of claim 11, wherein the signal voltage comprises at least one of an address voltage, a scan voltage, and a sustain voltage.

13. The plasma display device of claim 12, wherein the first switch is turned on in response to the signal voltage supplying switch being turned on to supply at least one of the address voltage, the scan voltage, and the sustain voltage.

14. The plasma display device of claim 12, wherein the second switch is turned on in response to the signal voltage supplying switch being turned on to supply a ground voltage.
